(19) United States
(12) Patent Application Publication
(10) Pub. No.: US 2025/0364709 A1
(43) Pub. Date: Nov. 27, 2025

(54) BATTERY MODULE INCLUDING SEALING PAD

(71) Applicant: SK ON CO., LTD., Seoul (KR)

(72) Inventors: Jin Woo SON, Daejeon (KR); Gang U LEE, Daejeon (KR)

(21) Appl. No.: 19/206,057

(22) Filed: May 13, 2025

(30) Foreign Application Priority Data
May 24, 2024 (KR) 10-2024-0067975

(51) Int. Cl. H01M 50/60; A62C 3/16; A62D 1/02; H01M 50/204; H01M 50/296; H01M 50/507; H01M 50/588

(52) U.S. Cl. CPC H01M 50/668; A62C 3/16; A62D 1/0071; H01M 50/296; H01M 50/507; H01M 50/588; H01M 50/204

(57) ABSTRACT

A battery module according to an embodiment of the present disclosure may include: a plurality of battery cells; a housing accommodating the plurality of battery cells in an internal accommodating space and including a bent portion bent at a predetermined curvature; and a sealing pad attached to the housing to at least partially contact the bent portion, wherein the sealing pad includes: a pad body corresponding at least partially to the bent portion; and a stress mitigating portion disposed in a portion of the pad body corresponding to the bent portion and dispersing stress in a portion thereof corresponding to the bent portion.

### CROSS-REFERENCE TO RELATED APPLICATION(S)

This patent document claims the priority and benefits of Korean Patent Application No. 10-2024-0067975 filed on May 24, 2024, the disclosure of which is incorporated herein by reference in its entirety.

### TECHNICAL FIELD

The present disclosure relates to a battery module including a sealing pad.

### BACKGROUND

Secondary batteries have the convenience of being able to be charged with or discharged of electricity therein or therefrom, unlike primary batteries, and are thus receiving significant attention as a power source for various mobile devices and electric vehicles.

These secondary batteries may include battery cells in which an electrode assembly formed by stacking a cathode plate, an anode plate and a separator or by winding the same in a roll shape is accommodated inside a case. A plurality of battery cells may be stacked in a predetermined direction and accommodated in a battery module or a battery pack.

Meanwhile, the case of the battery module or the battery pack may be formed in various shapes, such as being convexly bent, depending on the specifications. In this case, when an adhesive structure is disposed on the convex portion described above, stress may be concentrated on the convex portion so that adhesion may be deintercalated.

### SUMMARY

According to an aspect of the present disclosure, provided is a battery module in which a sealing pad attached to a housing may be prevented from being detached.

According to an aspect of the present disclosure, provided is a battery module including a sealing pad having excellent adhesiveness regardless of a shape of the housing.

A battery module of the present disclosure may be widely applied to electric vehicles, battery charging stations, and devices in green technology fields such as solar power generation and wind power generation using other batteries. Additionally, the battery module of the present disclosure may be used in eco-friendly electric vehicles, hybrid vehicles, or the like, to prevent climate change by suppressing air pollution and greenhouse gas emissions.

A battery module of the present disclosure may include: a plurality of battery cells; a housing accommodating the plurality of battery cells in an internal accommodating space and including a bent portion bent at a predetermined curvature; and a sealing pad attached to the housing to at least partially contact the bent portion, and the sealing pad includes: a pad body corresponding at least partially to the bent portion; and a stress mitigating portion disposed in a portion of the pad body corresponding to the bent portion and dispersing stress in a portion thereof corresponding to the bent portion.

In an embodiment, the housing may include a terminal hole through which the accommodating space communicates with an outside of the housing, and the sealing pad may be disposed to surround at least a portion of a vicinity of the terminal hole.

In an embodiment, the bent portion may be formed in the vicinity of the terminal hole.

In an embodiment, the bent portion may be formed convexly toward the accommodating space.

In an embodiment, the pad body may include a first surface facing and contacting the housing and a second surface, opposite to the first surface, and facing the accommodating space, and the stress mitigating portion may be formed on the second surface.

In an embodiment, the first surface of the pad body may be disposed to at least partially contact the bent portion.

In an embodiment, the stress mitigating portion may include at least one notch groove formed by recessing at least a portion thereof in a direction oriented from the second surface toward the first surface.

In an embodiment, the at least one notch groove may be disposed to face the bent portion.

In an embodiment, the bent portion may be formed convexly in a direction oriented toward the at least one notch groove.

In an embodiment, the stress mitigating portion may include a plurality of notch grooves arranged in a predetermined pattern.

In an embodiment, the plurality of notch grooves may form a predetermined pattern arranged in one or more rows in a predetermined direction.

In an embodiment, the battery module may further include: a busbar assembly electrically connected to the plurality of battery cells; and a terminal portion electrically connected to the busbar assembly and exposed to the outside of the housing through the terminal hole, and the sealing pad may be disposed to at least partially surround the terminal portion in the vicinity of the terminal hole.

In an embodiment, the housing further may include: a bottom cover supporting the plurality of battery cells; and a top cover disposed to face the bottom cover, and the terminal hole may be disposed in the top cover.

In an embodiment, the accommodating space may be provided to allow a fluid to be injected, and the sealing pad may be provided to prevent the fluid from leaking through the terminal hole.

In an embodiment, the fluid may include a liquid foam preventing or extinguishing fire, and the sealing pad may be provided to prevent the liquid foam injected into the accommodating space from leaking.

In an embodiment, the pad body may be disposed such that at least a portion of the pad body is in contact with the bent portion, and the stress mitigating portion may be disposed to face the bent portion.

Additionally, a battery module of the present disclosure may include: a plurality of battery cells; a housing accommodating the plurality of battery cells in an accommodating space and including a through-hole penetrating the housing to communicate with the outside and a bent portion convexly bent toward the accommodating space in a vicinity of the through-hole; and a sealing pad disposed to surround at least a portion of the through-hole, and a liquid foam provided for fire prevention or fire extinguishment may be injected into the accommodating space of the housing, the sealing pad may be provided to prevent the liquid foam from leaking out of the housing through the through-hole, and the sealing pad may include: a pad body disposed to at least partially contact the bent portion; and a stress mitigating portion provided to face the bent portion in the pad body and dispersing stress applied to the pad body by the bent portion.

In an embodiment, the stress mitigating portion may include at least one notch groove formed by recessing at least a portion thereof in the pad body.

As described above, the solution according to the present disclosure has been described, but this is exemplary, and it should be understood that even if other components not mentioned herein are added, they belong to the present disclosure.

According to an embodiment of the present disclosure, it may be possible to provide a battery module in which in which a sealing pad attached to a housing may be prevented from being detached.

According to an embodiment of the present disclosure, it may be possible to provide a battery module including a sealing pad having excellent adhesiveness regardless of a shape of the housing.

### BRIEF DESCRIPTION OF DRAWINGS

Certain aspects, features, and advantages of the present disclosure are illustrated by the following detailed description with reference to the accompanying drawings.

FIG. 1 is a perspective view of a battery module according to an embodiment of the present disclosure.

FIG. 2 is an exploded perspective view of a battery module according to an embodiment of the present disclosure.

FIG. 3 is an enlarged view of part A of FIG. 2 viewed in a different direction.

FIG. 4 is an enlarged view of part B of FIG. 3.

FIG. 5 is a cross-sectional view taken in a Y-axis direction in FIG. 3.

FIG. 6 is a view of a sealing pad according to an embodiment.

FIG. 7 is a view of a sealing pad according to another embodiment.

### DETAILED DESCRIPTION

Prior to describing the embodiments in detail, it should be understood that the terms used in the specification and the appended claims should not be construed as being limited to general and dictionary meanings, but interpreted based on the meanings and concepts corresponding to technical aspects of the present disclosure on the basis of the principle that the inventor is allowed to define terms appropriately for the best explanation.

The same reference numbers or symbols described in each drawing represent components or elements that perform substantially the same functions. For convenience of description and understanding, the same reference numbers or symbols may be used in different embodiments.

The singular also includes the plural unless specifically stated otherwise in the phrase. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Furthermore, hereinafter, it should be noted in advance that the expressions such as “above,” “upper,” “below,” “beneath,” “lower,” “side,” “front,” and “rear” are based on the direction illustrated in the drawings, and may be expressed differently if the direction of the object is changed.

Additionally, in the present specification and claims, terms including ordinal numbers such as “first” and “second” may be used to distinguish between components. These ordinal numbers are used to distinguish the same or similar components from each other, and the meaning of the terms should not be construed as limited by the use of these ordinal numbers. For example, the components combined with these ordinal numbers should not be construed as limiting the order of use or arrangement of the components. If necessary, the ordinal numbers may be used interchangeably.

Hereinafter, the present disclosure will be described in detail with reference to the drawings. However, this is merely exemplary and the present disclosure is not limited to the specific embodiments described as exemplary.

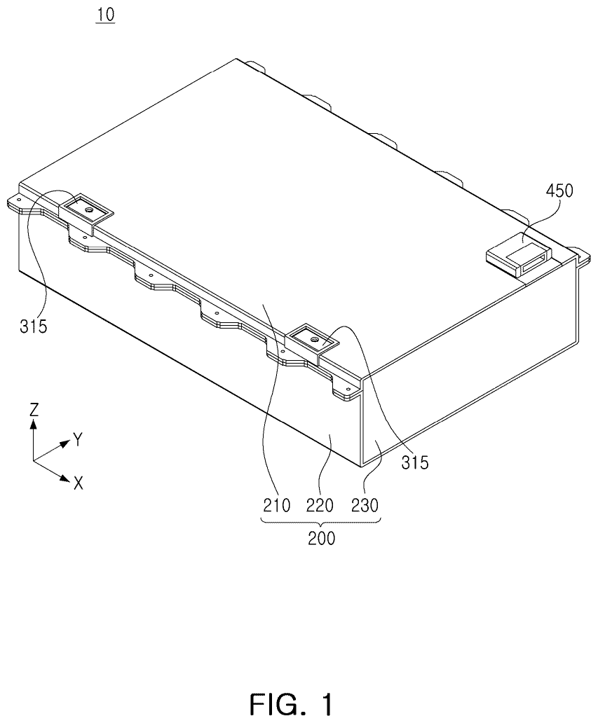

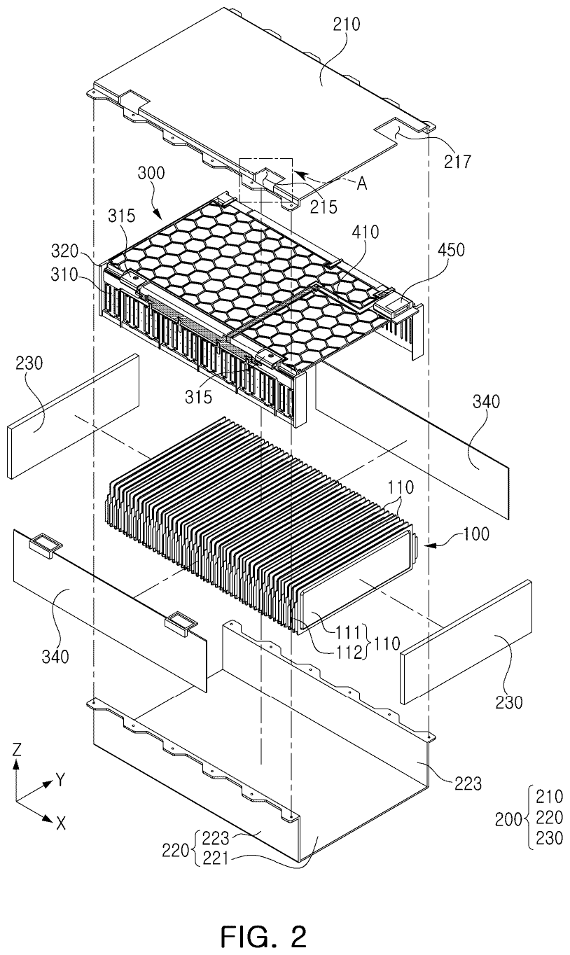

FIG. 1 is a perspective view of a battery module according to an embodiment of the present disclosure, and FIG. 2 is an exploded perspective view of a battery module according to an embodiment of the present disclosure.

Referring to FIGS. 1 and 2, a battery module 10 to which a sealing pad 500 of the present disclosure is attached will first be described.

The battery module 10 may include a cell assembly 100 including a plurality of battery cells 110, a housing 200 having an accommodating space accommodating the battery cells, a bus bar assembly 300 electrically connected to the battery cells 110, a circuit portion 410 detecting various electric signals of the battery cells 110, and a connector 450 connected to the circuit portion 410 and connected to the outside.

The plurality of battery cells 110 accommodated in the battery module 10 may be stacked in one direction (X-axis direction) to form at least a portion of the cell assembly 100. Each battery cell 110 may output or store electrical energy. In the cell assembly 100, the battery cells 110 may be electrically connected to each other through the busbar assembly 300.

The plurality of battery cells 110 may be configured to convert chemical energy into electrical energy to supply power to an external circuit, or to receive power from the outside and convert electrical energy into chemical energy to store electricity. For example, the battery cell 110 may be configured as a nickel metal hydride (Ni-MH) battery or a lithium ion (Li-ion) battery capable of being charged with or discharged of electricity therein or therefrom.

The plurality of battery cells 110 may be provided by accommodating an electrode assembly (not illustrated) formed by stacking a cathode plate and an anode plate. The electrode assembly may be configured in a form in which the cathode plate and the anode plate are stacked with a separator interposed therebetween in a state in which wide surfaces thereof face each other. The separator may be configured to prevent electrical short-circuiting between the cathode plate and the anode plate and to allow for ion flow. For example, the separator may include a porous polymer film or a porous nonwoven fabric.

Additionally, the electrode assembly may have a jelly roll form, formed by winding in a predetermined direction, and may thus be accommodated in a case in various manners, such as a stacking type, a zigzag-folding type, a stack-folding type, and the like.

The plurality of battery cells 110 may be pouch-type, prismatic-type, or cylindrical-type secondary batteries depending on the structure of the case.

The battery cell 110 of the present disclosure may include a case 111 accommodating the electrode assembly and a lead tab 112 protruding from at least one side of the case and electrically connected to a bus bar 310 described below.

Additionally, the cell assembly 100 may further include a protective pad (not illustrated). The protective pad may cause damage to other battery cells due to the occurrence of an event (e.g., a situation in which high temperature gas or flame is generated, or a battery cell expand abnormally). For example, a protective member may include a material capable of blocking heat to prevent heat from being transmitted between adjacent battery cells 110. Alternatively, the protective member may include a material capable of applying surface pressure to the battery cell 110, and may function to suppress expansion of the battery cell 110.

The plurality of battery cells 110 included in the cell assembly 100 may be electrically connected to each other through the busbar assembly 300 via the lead tab 112. At least a portion of the busbar assembly 300 may face the cell assembly 100 in a direction, perpendicular to a cell stacking direction (Y-axis direction).

The housing 200 provides an internal space in which one or more cell assemblies 100 may be accommodated. The housing 200 may be formed of a material having a predetermined degree of rigidity to protect the cell assemblies 100 and other electrical components accommodated in the internal space from external impacts. For example, the housing 200 may include a metal material such as aluminum.

The housing 200 may include a first cover 210, a second cover 220, and an end plate 230 covering a side portion, which are disposed to face the cell assemblies 100 in a height direction (Z-axis direction).

The first cover 210 may be disposed above the cell assemblies 100 to cover the cell assemblies 100. The first cover 210 may include a terminal hole 215 through which a terminal portion 315 described below is exposed, and a connector hole 217 through which a connector 350 is exposed. Here, the terminal hole 215 and the connector hole 217 are collectively referred to as a ‘through-hole.’ In other words, the through-hole collectively refers to a hole formed in the housing 200, including the terminal hole 215 and the connector hole 217.

Since the first cover 210 is disposed above the cell assembly 100, the first cover 210 may also be referred to as a “top cover.”

The second cover 220 may be disposed in a lower portion of the cell assembly 100 to support the cell assembly 100. The second cover 220 may include a lower plate 221 facing a top cover 210 and supporting the lower portion of the cell assembly 100, and a side plate 222 disposed on a side portion of the cell assembly 100, e.g., in a longitudinal direction (Y-axis direction) of the cell assembly 100.

Since the second cover 220 is arranged below the cell assembly 100, the second cover 220 may also be referred to as a “bottom cover.”

The end plate 230 may cover a portion not covered with the top cover 210 and the bottom cover 220. For example, the end plates 230 may be provided in a pair and may be disposed to cover both side surfaces of the cell assembly 100 in a stacking direction (X-axis direction).

However, the structure of the housing 200 is not limited thereto, and may have any shape as long as the housing 200 has an internal space in which at least one cell assembly 100 may be accommodated. For example, the housing 200 may be formed integrally with the top cover 210 and may be configured as an integral monoframe in which both side surfaces are open.

A heat dissipation member (not illustrated) may be disposed between the cell assembly 100 and the housing 200. The heat dissipation member (not illustrated) may be provided so that one surface thereof is in contact with the cell assembly 100 and the other surface opposite to the one surface is in contact with the housing 200. The heat dissipation member (not illustrated) may be provided as a thermal adhesive. The heat dissipation member (not illustrated) may fill a space between the cell assembly 100 and the housing 200 to enable more active heat transfer by conduction. Accordingly, the heat dissipation efficiency of the battery module 10 may be increased.

The busbar assembly 300 may include a busbar 310 electrically connecting one battery cell 110 to another battery cell 110 and a support frame 320 supporting the busbar 310.

Some of the busbars 310 of the busbar assembly 300 may include a terminal portion 315 that may be electrically connected to a power source outside the battery module 10. The terminal portion 315 may be exposed to the outside of the battery module 10 through the terminal hole 215 formed in the housing 200.

The busbar 310 may be coupled to a support frame 320. The support frame 320 may be formed of an electrically insulating material to prevent an unintended short circuit from occurring between the plurality of busbars 310. The support frame 320 may face at least one side of the cell assembly 100.

The circuit portion 410 may be connected to the cell assembly 100 to detect an operating status, an environmental status, humidity, current pressure, and the like, of the battery cells 110. The connector 450 may connect the circuit portion 410 and the outside of the battery module 10, for example, a Battery Management System (BMS) to each other, thus transmitting and receiving information on the battery cell 110 to and from the outside. The connector 450 may be exposed to the outside of the battery module 10 through a connector hole 217 formed in the housing 200.

Additionally, the battery module of the present disclosure may include an insulating cover 340 formed of an electrically insulating material and disposed between the busbar assembly 300 and the housing 200, specifically, the side plate 222 to electrically protect the battery cell 110.

For example, the insulating cover 340 may be disposed between the busbar assembly 300 and the housing 200 so as to face the busbar assembly 300. The insulating cover 340 may include an insulating material, and may thus block electrical connection between the busbar assembly 300 and the housing 200. For example, the insulating cover 340 may be formed of a plastic injection molded product including polypropylene or modified polyphenylene oxide (MPPO). However, the material of the insulating cover 340 is not limited thereto. As the insulating cover 340 is disposed, an electrical short circuit may be prevented between the cell assembly 100 and the housing 200, or between the bus bar 310 and the housing 200.

The bus bar 310 may be formed of a conductive material, and serves to electrically connect a plurality of battery cells 110 to each other. The bus bar 310 may be electrically connected to the lead tab 112 of the battery cell 110. Various welding methods, including laser welding, may be applied to connect the bus bar 310 and the lead tab 112. However, the connection method is not limited to welding, and any connection method that may electrically conduct two metallic materials may be used.

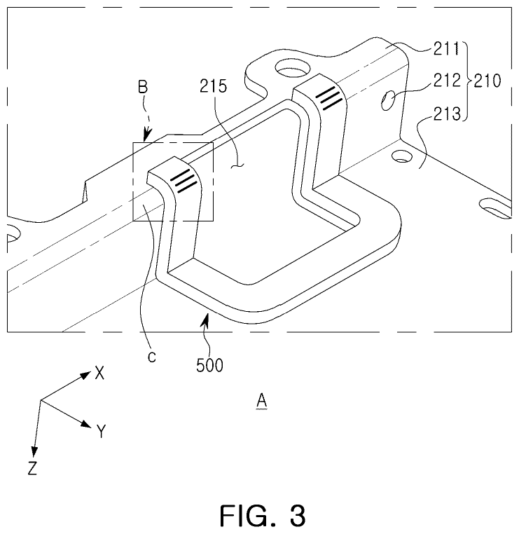

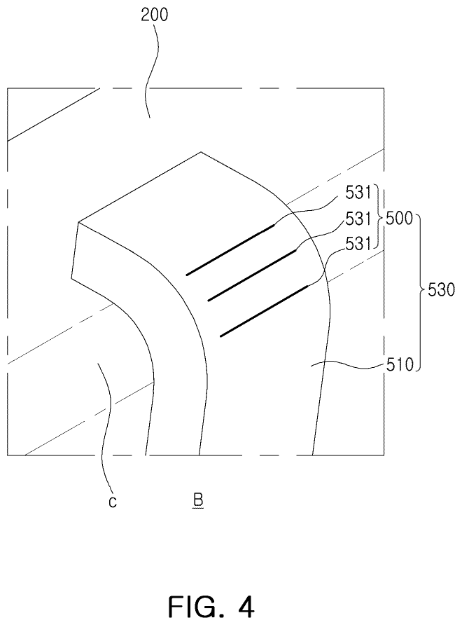

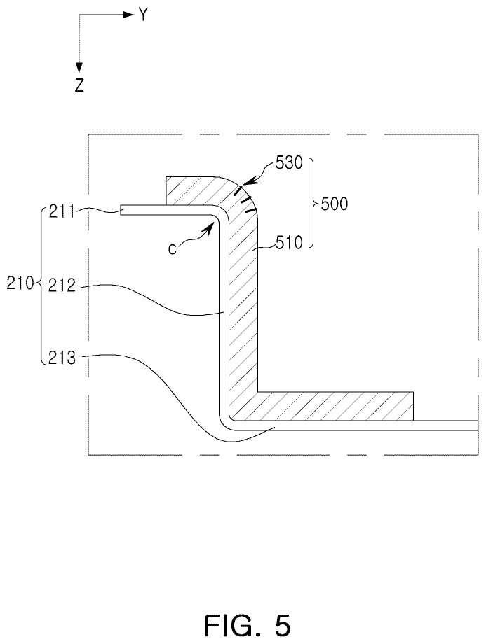

FIG. 3 is an enlarged view of part A of FIG. 2 viewed from a different direction, FIG. 4 is an enlarged view of part B of FIG. 3, and FIG. 5 is a cross-sectional view taken along a Y-axis direction in FIG. 3.

According to an embodiment of the present disclosure, a fluid may be accommodated in the accommodating space of the housing 200. The fluid referred to in the present disclosure may denote an insulating cooling fluid for cooling the battery cell 110 in the accommodating space of the housing 200 or a liquid foam preventing thermal runaway of the battery cells inside the accommodating space or preventing or extinguishing fire occurring in the accommodating space. In this case, in order to prevent the fluid from leaking through a hole (e.g., a terminal hole 215 or a connector hole 217) formed in the housing 200, the sealing pad 500 may be disposed a vicinity thereof (see FIG. 3). The sealing pad 500 may include, for example, a material such as EPDM formed of a rubber material.

According to an embodiment, the sealing pad 500 may be attached to the housing 200 and disposed in the accommodating space.

Meanwhile, the “cooling fluid” in the present disclosure refers to a fluid acting as an electrical insulator, and may be, for example, an insulating oil having non-conductive oil as a main component. However, the cooling fluid of the present disclosure is not limited thereto, and any fluid having the property capable of cooling the battery cell 110 through heat exchange with the battery cell 110 may be included therein.

Additionally, the “liquid foam” in the present disclosure denotes that a foam material for preventing an event such as thermal runaway of the battery cell 110 or preventing or extinguishing fire occurring in the battery cell 110 includes a solvent.

Additionally, the present disclosure may be applied even if the housing 200 does not accommodate a fluid. In other words, the scope of the present disclosure is not limited, depending on the presence or absence of the fluid, and even if the sealing pad 500 is disposed in a bent portion c of the housing 200, this should be considered to belong to the present disclosure.

Meanwhile, the sealing pad 500 may be attached to the housing 200 with an adhesive or the like, but there may be a problem that the adhesive strength is reduced due to the shape of the housing 200 (e.g., a curved portion).

Referring to FIG. 2 again, there is no bent portion of the housing 200 in a vicinity of the connector hole 217, but the terminal hole 215 may structurally have a bent portion (c, see FIG. 3) formed in the vicinity thereof. That is, the terminal hole 215 may be formed to at least partially penetrate through the bent portion c. The bent portion c may be formed by bending an appearance of the housing 200 at a predetermined curvature.

That is, the housing 200 may include a bent portion c having a predetermined curvature. The bent portion c may be formed convexly toward the internal accommodating space of the housing 200 or the cell assembly 100.

In this case, among the sealing pads, a sealing pad 500 (see FIG. 3) attached in the vicinity of the terminal hole 215 may also be attached to correspond to the bent portion c. In this case, the sealing pad 500 may experience a phenomenon in which stress is concentrated in a portion thereof corresponding to the bent portion c and the adhesive strength of the portion is weakened, causing the sealing pad 500 to be lifted and detached in a portion overlapping the bent portion c.

Meanwhile, in the present disclosure, ‘corresponding to the bent portion c’ may denote that at least a portion thereof is disposed to overlap the bent portion c, disposed to face the bent portion c, or disposed to contact the bent portion c. In other words, this may denote that a shape of the sealing pad 500 is convexly bent such that at least a portion thereof corresponds to the bent portion c by the bent portion c.

When the sealing pad 500 is detached, a fluid, for example, a liquid foam, may leak out through the terminal hole 215, so that it may be decisive to improve the adhesive strength of the sealing pad 500 regardless of the bending shape of the housing 200.

That is, the sealing pad 500 of the present disclosure may be provided to prevent the fluid, such as a liquid foam, from leaking out through the through-hole, regardless of the shape of the bent portion c.

Here, referring to FIGS. 3 to 5 together, the present disclosure may include the sealing pad 500 disposed to overlap the bent portion c of the housing 200, but the sealing pad 500 may include a stress mitigating portion 530 provided to correspond at least partially to the bent portion C.

FIG. 3 is an inverted view of part A in FIG. 2. That is, FIG. 3 is a view of part A taken from the accommodating space of the housing 200.

The sealing pad 500 of the present disclosure may include a pad body 510 disposed to correspond at least partially to the bent portion c, and a stress mitigating portion 530 disposed in a position corresponding to the bent portion c in the pad body 510 to disperse stress in a portion thereof corresponding to the bent portion c. In other words, the sealing pad 500 may include the pad body 510 disposed to at least partially contact the bent portion c and the stress mitigating portion 530 provided to face the bent portion c in the pad body 510 and dispersing the stress applied to the pad body 510 by the bent portion c.

The sealing pad 500 may be attached to the housing 200 to surround the terminal hole 215. For example, the sealing pad 500 may be attached to an internal surface (a surface facing the accommodating space) of the top cover 210 having the terminal hole 215 formed therein. However, the present disclosure is not limited thereto, and may also include the sealing pad 500 attached to the housing 200 to surround the connector hole 217.

According to an embodiment, the top cover 210 may include a first plate 211 coupled to the bottom cover 220, a second plate 212 extending from the first plate, and a third plate 213 extending from the second plate 212 to cover the cell assembly 100.

According to an embodiment, a bent portion c may be formed between the first plate 211 and the second plate 212 or between the second plate 212 and the third plate 213.

The bent portion c may refer to a portion bent between at least two of the first plate 211, the second plate 212, or the third plate 213.

In FIG. 3, two portions in which the plates are bent are provided between the first plate 211 and the second plate 212 and between the second plate 212 and the third plate 213, but thereamong, in this specification, a portion bent between the first plate 211 and the second plate 212 is referred to as a ‘bent portion c’ and will be described.

Referring to FIG. 4, the sealing pad 500 may include a pad body 510 coupled or attached to the housing 200 to correspond to the bent portion c and a stress mitigating portion 530 disposed to correspond to the bent portion c in the pad body 510.

Meanwhile, the meaning of “corresponding to the bent portion c” in this specification does not only mean directly contacting the bent portion c, but may also mean being disposed to overlap the bent portion c in a predetermined direction (the Y-axis direction or the Z-axis direction in the drawing). That is, this may mean that at least a portion of the sealing pad 500 is at least partially convexly bent at a radius of curvature corresponding to the bent portion c by the bent portion c.

Here, the “portion in which the sealing pad 500 overlaps the bent portion c” may mean ‘at least a portion of the pad body 510 covering the bent portion c’. The stress mitigating portion 530 may be disposed in the ‘at least a portion of the pad body 510 covering the bent portion c’.

The pad body 510 may include a first surface (not illustrated, a surface at least partially contacting the housing 200) facing and contacting the housing 200 and a second surface (not illustrated), opposite to the first surface, and facing the accommodating space. The stress mitigating portion 530 may be formed on the second surface.

In this case, the first surface of the pad body 510 may be disposed to at least partially contact the bent portion c. Additionally, the stress mitigating portion 530 may include at least one notch groove 531 formed by recessing at least a portion thereof in a direction oriented (thickness direction of the pad body 510) from the second surface to the first surface. In this case, the at least one notch groove 531 may be disposed in the pad body 510 so as to face the bent portion c in order to mitigate stress concentration caused by the bent portion c.

Meanwhile, as illustrated in the drawing, the bent portion c may be provided in a shape convexly bent toward the accommodating space or the at least one notch groove 531. Accordingly, the pad body 510 may also be disposed in a shape in which at least a portion thereof has a radius of curvature corresponding to the bent portion toward the accommodating space and at least a portion thereof is convexly bent.

Referring to FIG. 5, the stress mitigating portion 530 may prevent the pad body 510 from being detached from one side (a side close to a-Y-axis) of the bent portion c by concentrating the stress in the vicinity of the bent portion c. The stress mitigating portion 530 is provided so as to disperse the stress concentrated on a portion of the pad body 510 overlapping the bent portion c.

For example, the stress mitigating portion 530 may include one or more notch grooves 531. The notch grooves 531 may be formed as recessed grooves along a thickness of the pad body 510.

For example, the notch groove 531 in the drawing is schematically drawn in bold lines for ease of understanding, but the notch groove 531 of the present disclosure may be formed as a groove recessed in a thickness direction of the pad body 510 or as a sheath shape cut in a thickness direction. In a portion in which the pad body 510 and the bent portion c overlap each other, stress is concentrated so that one surface of the pad body 510 (a surface in a −Z-axis direction) is opened by the bent portion c, but since the stress concentrated on the pad body 510 is dispersed by the notch groove 531, the pad body 510 may be prevented from being lifted off the housing 200.

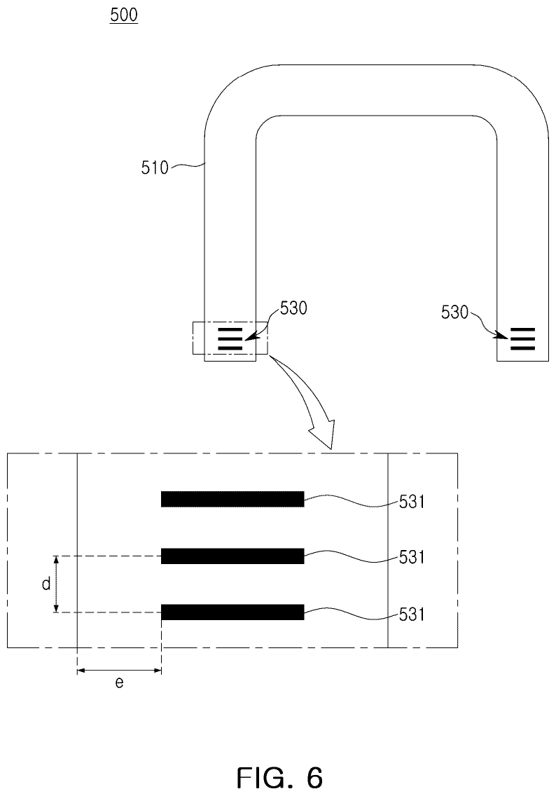

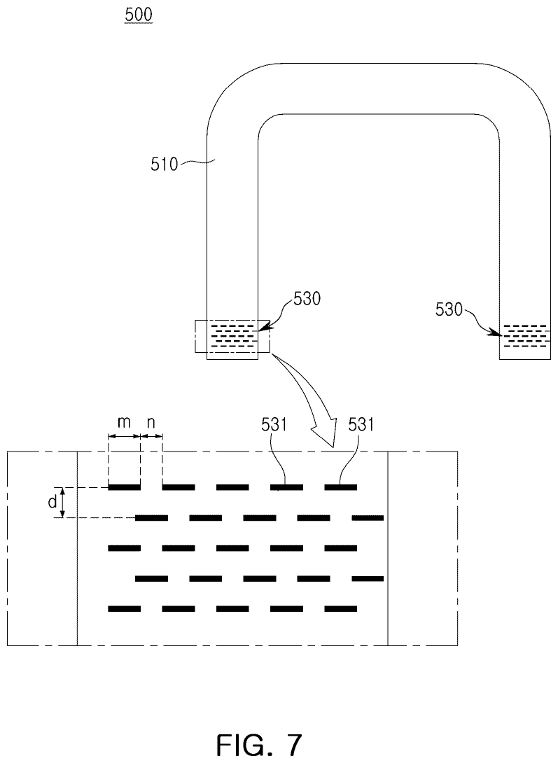

Referring to FIGS. 6 and 7 in advance, the notch groove 531 may be formed in a pattern in a predetermined direction.

Additionally, the stress mitigating portion 530 may be formed on a surface of the pad body 510 that is bent and stretched by the bent portion c. Specifically, referring to FIG. 5, among both surfaces of the pad body 510 in the thickness direction (Z-axis direction), one surface (a surface disposed in the −Z-axis direction) may be provided to be opened by the bent portion c. Accordingly, the notch groove 531 of the stress mitigating portion 530 may be formed by being recessed in the one surface.

In other words, an internal surface of the housing 200 may be formed convexly toward the accommodating space by the bent portion c, and an external surface opposite thereto may be formed concavely. Additionally, the stress mitigating portion 530 may be disposed to overlap the convexly formed portion.

Meanwhile, the stress mitigating portion 530 of the present disclosure is not limited thereto. For example, the stress mitigating portion 530 may also be disposed in a bent portion between the second plate 212 and the third plate 213. Since the stress in this portion is concentrated on a surface (a surface in a +Z-axis direction in the drawing) in contact with the top cover 210, the stress mitigating portion 530 may be disposed on a surface (a surface in the +Z-axis direction) in contact with the top cover 210 among both side surfaces of the pad body 510 in the thickness direction (Z-axis direction).

FIG. 6 is a view of a sealing pad according to an embodiment, and FIG. 7 is a view of a sealing pad according to another embodiment. Referring to FIGS. 6 and 7, the stress mitigating portion 530 may be formed in various patterns formed by a plurality of notch grooves 531.

Referring to FIG. 6, the stress mitigating portion 530 may be formed in a pattern in which a plurality of notch grooves 531 are arranged in a single row. The number of notch grooves 531 in the drawing is three, but is not limited thereto.

Additionally, a vertical distance d between notch grooves 531 adjacent to each other and a distance between the notch grooves 531 and one end of the pad body 510 in an extension direction of the notch grooves 531 (e.g., hereinafter referred to as “end distance”) may vary depending on the shape, the size, the radius of curvature, and the like, of the bent portion c.

For example, the vertical distance d between the notch grooves 531 according to an embodiment may be 1 mm to 3 mm, and an end distance e may be 1.25 mm to 3.75 mm.

For another example, the vertical distance d between the notch grooves 531 and the end distance e may be 1:1.25 (d=1.25e).

Referring to FIG. 7, the stress mitigating portion 530 may form a predetermined pattern with a plurality of notch grooves 531 in a plurality of rows. For example, a first notch groove group and a second notch groove group in which the plurality of notch grooves 531 are misaligned from each other may be arranged in the stress mitigating portion 530.

Additionally, a distance d between adjacent notch grooves 531, an extension length m of the notch grooves 531, and a horizontal distance n between the notch grooves 531 according to the extension direction of the notch grooves 531 may vary depending on the shape, the size, the radius of curvature, and the like, of the bent portion c.

For example, the vertical distance d between the notch grooves 531 may be 1.25 mm to 3.75 mm, the extension length m of the notch grooves 531 may be 0.5 mm to 1.5 m, and the horizontal distance n between the notch grooves 531 may be 0.5 mm to 1.5 m. The extension length m of the notch grooves 531 may be equal to or greater than the horizontal distance n between the notch grooves 531.

As another example, the extension length m of the notch grooves 531 and the vertical distance d between the notch grooves 531 may be 1:2.5 (d=2.5 m), and the horizontal distance n of the notch grooves 531 and the vertical distance d between the notch grooves 531 may be 1:2.5 (d=2.5n).

Although various embodiments of the disclosed technology have been described in detail above, the scope of the disclosed technology is not limited thereto, and it will be apparent to those skilled in the art that modifications and variations could be made without departing from the scope of the disclosed technology as defined by the appended claims. In addition, some components may be deleted and implemented in the above-described example embodiments, and each of the embodiments may be combined and implemented with each other.

The above-described content is merely an example of applying the principle of the present disclosure, and other components may be further included without departing from the scope of the present disclosure.

What is claimed is:

1. A battery module, comprising:
a plurality of battery cells;
a housing accommodating the plurality of battery cells in an internal accommodating space and including a bent portion bent at a predetermined curvature; and
a sealing pad attached to the housing to at least partially contact the bent portion,
wherein the sealing pad includes:
a pad body corresponding at least partially to the bent portion; and
a stress mitigating portion disposed in a portion of the pad body corresponding to the bent portion and dispersing stress in a portion thereof corresponding to the bent portion.

2. The battery module of claim 1,
wherein the housing includes a terminal hole through which the accommodating space communicates with an outside of the housing, and
the sealing pad is disposed to surround at least a portion of a vicinity of the terminal hole.

3. The battery module of claim 2,
wherein the bent portion is formed in the vicinity of the terminal hole.

4. The battery module of claim 3,
wherein the bent portion is formed convexly toward the accommodating space.

5. The battery module of claim 1,
wherein the pad body includes a first surface facing and contacting the housing and a second surface, opposite to the first surface, and facing the accommodating space, and
the stress mitigating portion is formed on the second surface.

6. The battery module of claim 5,
wherein the first surface of the pad body is disposed to at least partially contact the bent portion.

7. The battery module of claim 6,
wherein the stress mitigating portion includes at least one notch groove formed by recessing at least a portion thereof in a direction oriented from the second surface toward the first surface.

8. The battery module of claim 7,
wherein the at least one notch groove is disposed to face the bent portion.

9. The battery module of claim 7,
wherein the bent portion is formed convexly in a direction oriented toward the at least one notch groove.

10. The battery module of claim 1,
wherein the stress mitigating portion includes a plurality of notch grooves arranged in a predetermined pattern.

11. The battery module of claim 10,
wherein the plurality of notch grooves form a predetermined pattern arranged in one or more rows in a predetermined direction.

12. The battery module of claim 2, further comprising:
a busbar assembly electrically connected to the plurality of battery cells; and
a terminal portion electrically connected to the busbar assembly and exposed to the outside of the housing through the terminal hole,
wherein the sealing pad is disposed to at least partially surround the terminal portion in the vicinity of the terminal hole.

13. The battery module of claim 2,
wherein the housing further includes:
a bottom cover supporting the plurality of battery cells; and
a top cover disposed to face the bottom cover,
wherein the terminal hole is disposed in the top cover.

14. The battery module of claim 2,
wherein the accommodating space is provided to allow a fluid to be injected, and
the sealing pad is provided to prevent the fluid from leaking through the terminal hole.

15. The battery module of claim 14,
wherein the fluid includes a liquid foam that prevents or extinguishes fire, and
the sealing pad is provided to prevent the liquid foam injected into the accommodating space from leaking.

16. The battery module of claim 1,
wherein the pad body is disposed such that at least a portion of the pad body is in contact with the bent portion, and
the stress mitigating portion is disposed to face the bent portion.

17. A battery module, comprising:
a plurality of battery cells;
a housing accommodating the plurality of battery cells in an accommodating space, and including a through-hole penetrating the housing to communicate with the outside and a bent portion convexly bent toward the accommodating space in a vicinity of the through-hole; and
a sealing pad disposed to surround at least a portion of the through-hole,
wherein a liquid foam provided for fire prevention or fire extinguishment is injected into the accommodating space of the housing,
the sealing pad is provided to prevent the liquid foam from leaking out of the housing through the through-hole,
and the sealing pad includes:
a pad body disposed to at least partially contact the bent portion; and
a stress mitigating portion provided to face the bent portion in the pad body and dispersing stress applied to the pad body by the bent portion.

18. The battery module of claim 17,
wherein the stress mitigating portion includes at least one notch groove formed by recessing at least a portion thereof in the pad body.
